(19) United States
(12) Patent Application Publication
(10) Pub. No.: US 2023/0217954 A1
(43) Pub. Date: Jul. 13, 2023

(54) ICE CREAM COMPOSITION CONTAINING PROTEINOGENIC AMINO ACIDS

(71) Applicants: Albert Wionzek, Ruecheid (DE); Marco Wionzek, Neuwied Rheinland-Pfalz (DE)

(72) Inventors: Albert Wionzek, Ruecheid (DE); Marco Wionzek, Neuwied Rheinland-Pfalz (DE)

(21) Appl. No.: 17/797,703

(22) PCT Filed: Feb. 4, 2021
(86) PCT No.: PCT/EP2021/052677

§ 371 Date: Aug. 4, 2022

(30) Foreign Application Priority Data
Feb. 4, 2020 (DE) 10 2020 102 738.9

(51) Int. Cl. A23G 9/38; A23G 9/36

(52) U.S. Cl. CPC A23G 9/38; A23G 9/366

(57) ABSTRACT

The invention relates to a sugar-free ice cream composition for making ice cream that contains at least one liquid, the liquid being water and the ice cream composition being present in a solid, frozen, not-shapeable state at a temperature of −10° C., preferably −14° C., more preferred −18° C. The ice cream composition is lactose free and contains at least one first proteinogenic amino acid.

### PRIORITY CLAIM

This application is a U.S. national phase of International Patent Application No. PCT/EP2021/052677 filed Feb. 4, 2021; which claims the benefit of priority from Germany Patent Application No. 10 2020 102 738.9 filed Feb. 4, 2020, the contents of which are incorporated by reference.

### FIELD OF THE INVENTION

The present invention relates to a sugar-free and lactose-free ice cream composition for making an ice cream which contains at least water and at least one proteinogenic amino acid. At a temperature below −10° C., preferably −14° C., preferably −18° C. the ice cream composition is in a solid, frozen, not shapeable state.

### BACKGROUND OF THE INVENTION

In sport the body is very highly stressed, which not only affects the muscles and joints, but also the metabolism. Particularly in hot environments, the body consumes more energy and reaches its performance limit more quickly than on cooler days. At the same time amino acids are required to build up muscle mass or to prevent muscle loss, for example while running a marathon.

In order to raise this performance limit, or at least to maintain the performance for a long time, sportspeople frequently resort to performance-enhancing and performance-maintaining agents, which enable the body to recover consumed energy. Such compositions are often available in tablet form, so that they must also be carried when participating in the sport and must be consumed together with a drink.

Already some manufacturers even offer premixed drinks which contain corresponding performance-maintaining or performance-enhancing agents, so that sportspeople can consume this premixed drink without having to bring tablets with them. However, premixed drinks often have the disadvantage that they must contain preservatives in order to prevent the growth of microorganisms such as bacteria, fungi and viruses, as water-based liquids containing amino acid are the ideal nutrient medium for microorganisms, in particular when the container holding these liquids has been opened a number of times or—even more problematic—if the containers have been repeatedly brought to the mouth. Such additives have the disadvantage that they are not only toxic for microorganisms and some people have an allergic reaction to preservatives. In many cases some principal ingredients of the drinks can even trigger digestive problems.

A further disadvantage of premixed drinks is that during consumption they do not give rise to a refreshing experience. Especially in summer and when it is very hot, sportspeople need not only a lot of liquid and the performance-enhancing or performance-maintaining agents, but also a refreshing experience in order to motivate and cool themselves.

### BRIEF DESCRIPTION OF THE DRAWINGS

Preferred and alternative examples of the present invention are described in detail below with reference to the following drawings.

FIG. 1: Exemplary ice cream composition which is surrounded by a package.

### DETAILED DESCRIPTION OF THE PREFERRED EMBODIMENT

The object of the present invention is therefore to provide a foodstuff which has a refreshing effect, contributes to maintaining performance and to muscle building and is easily digestible, but also contains no preservative and does not constitute a nutrient medium for microorganisms.

This object is achieved according to the features of claim 1, according to which a sugar-free ice cream composition for making ice cream contains at least one liquid. The liquid is water, and at a temperature below −10° C., preferably −14° C., preferably −18° C. the ice cream composition is in a solid, frozen, not shapeable state. The ice cream composition is lactose-free and contains at least one first proteinogenic amino acid. It is also conceivable that the ice cream composition contains at least one further, in particular non-proteinogenic amino acid. The consumption of an ice cream offers not only a refreshing effect, but, for example in a break in competition, provides the sports-playing athlete directly with an amino acid and water, so that a fluid loss can be compensated for. Since the ice cream contains no sugar and can be stored in the frozen state it is possible—unlike with liquid drinks—to omit preservatives.

Moreover, the ice cream composition can advantageously be heated, in particular after a packaging process and/or freezing. The ice cream composition can preferably be heated to a temperature below 90° C., preferably below 85° C., preferably below 80° C. and/or above 65° C., preferably above 70° C., preferably above 75° C. In this way the ice cream composition can be pasteurised. It is also advantageous if the ice cream composition is preservative-free. Without preservatives the formation of microorganisms which can have a harmful effect on the human body is very greatly inhibited.

Since the ice cream contains water it is freezable. The water is preferably soft or hard and has a hardness between below 8° dH, preferably below 10° dH, or above 10° dH, preferably above 14° dH. Because the ice cream composition is free of the sugar lactose, it does not trigger any digestive problems. The proteinogenic amino acid contained in the ice cream composition is advantageously suitable for protein synthesis and thus for forming protein and thus for providing energy and building muscles. It is also conceivable that the proteinogenic amino acid is an essential, non-essential or semi-essential amino acid.

In this case it is possible that the proteinogenic amino acid comprises one of the following amino acids: isoleucine, leucine, lysine, methionine, phenylalanine, threonine, tryptophan, valine or one of the amino acids alanine, arginine, aspartic acid, asparagine, glutamine, glutamic acid, glycine, histidine, proline, serine, tyrosine. These amino acids are particularly important for humans, and they can be well absorbed and processed by the human body.

The amino acids valine, leucine, isoleucine and glycine are—without limiting the invention—particularly suitable, because even close to the freezing point they are still sufficiently dissolved in this liquid. The 13th edition of the Merck Index gives the following solubilities for these amino acids:

TABLE 1
Water solubility of different amino acids
close to the freezing point of water

| Amino acid | Solubility in water |
|---|---|
| Valine | 83.4 g/l at 0° C. |
| Leucine | 22.7 g/l at 0° C. |
| Isoleucine | 37.9 g/l at 0° C. |
| Glycine | 25.0 g/100 m at 20° C. |

It will be recognized that according to the pharmacopoeias the amino acids are soluble even at a water temperature close to 0° C. Since dissolution is the prerequisite for any resorption, the tabular data emphasise that the aforementioned amino acids are particularly suitable.

It is also conceivable that the ice cream composition contains acids or salt for decreasing or increasing the pH value which are harmless according to food regulations. Such an acid enables the adjustment of the pH value in order to change the solubility of the amino acid for reasons of production technology.

It is also advantageous if the ice cream composition has at least one or more acidity regulators. These acidity regulators are preferably selected from at least one of the following substances: citric acid, sodium citrate, malic acid, acetic acid, fumaric acid, malates, gluconic acid, adipic acid or tartaric acid. The degree of acidity and/or the basicity of the ice cream composition is controllable by acidity regulators, so that the pH value of the ice cream composition can be kept constant.

It is also conceivable that the ice cream composition contains magnesium or magnesium salts, for example magnesium citrate and/or magnesium levulinate. As an additive, magnesium serves to relax the muscles and activates the adenosine triphosphate in the cells, so magnesium provided by the ice cream composition has a supportive effect for the energy metabolism and the muscle activity.

It is also possible that the ice cream composition contains another liquid, preferably an alternative to milk, for example lactose-free milk, oat milk, almond milk or soya milk. In this way the taste of the ice cream composition can be adapted so that it offers a familiar taste to the consumers.

In an advantageous embodiment the ice cream composition contains at least one second proteinogenic amino acid. Since the human body requires various amino acids to gain energy, for protein synthesis and therefore to build up body cells, the provision of a further, second amino acid by the ice cream composition is advantageous.

It is also advantageous if the ice cream composition has at least one third proteinogenic amino acid. Since the human body requires various amino acids to gain energy, for protein synthesis and therefore to build up body cells, the provision of a further, third amino acid by the ice cream composition is advantageous. It is also conceivable that the ice cream composition contains at more than three, for example four, five or more proteinogenic amino acids. In this case these proteinogenic amino acids can be selected from the group of essential, non-essential or semi-essential amino acids.

The proteinogenic amino acids are preferably selected from the group of essential amino acids, since these must be provided for the human body by food. Although there are certain situations in which the body also cannot synthesise non-essential amino acids for itself, it is advantageous if at least one, or two, or all of the proteinogenic amino acids in the ice cream composition are selected from the group of non-essential amino acids. Those amino acids which do not occur as non-essential amino acids are preferably selected from the group of essential amino acids. The proteinogenic amino acids are preferably selected from the group of essential amino acids, since these must be provided for the human body from food.

In a further embodiment the first amino acid comprises leucine, the second amino acid comprises valine and/or the third amino acid comprises isoleucine. These three amino acids are a structural component of the muscle tissue and therefore serve particularly well to maintain the muscle tissue and thus to maintain performance during sport. Furthermore, leucine, isoleucine and valine are not metabolised by the liver, but after absorption in the intestine they pass via the bloodstream directly into the muscles, where they can be processed for rebuilding the muscles of the body.

It is also conceivable that the first, second and/or third amino acid are used as L-enantiomers or as a racemic mixture. Furthermore, it is possible that one or more of the amino acids contained in the ice cream composition are used as L-enantiomers or as a racemic mixture. As a result the production costs are low and supply bottlenecks can be avoided.

It is also advantageous if the amino acids are present together in a quantity of more than 1 g, preferably more than 1.5 g, preferably more than 2 g and/or less than 6 g, preferably less than 5 g, preferably less than 4 g in a quantity of the ice cream composition. In this case a quantity of the first amino acid is preferably greater than 0.8 g, preferably greater than 1 g, preferably greater than 1.2 g and/or preferably less than 1.8 g, preferably less than 1.6 g, preferably less than 1.4 g. A quantity of the second and/or third amino acid is preferably greater than 0.2 g, preferably greater than 0.4 g, preferably greater than 0.6 g and/or preferably less than 1 g, preferably less than 1.8 g, preferably less than 1.7 g. Such a quantity of the amino acids is an optimal daily dose for sportspeople. A quantity of the ice cream composition preferably corresponds to the content, preferably the weight or volume, of a package for the ice cream composition and/or a portion size. Accordingly the quantity preferably corresponds to a weight between 40 g and 250 g. It is possible that the quantity corresponds to a weight less than 50 g or greater than 200 g. However, it is also conceivable that the quantity corresponds to a fraction or a proportion of the entire ice cream composition suitable for freezing. The quantity of the ice cream composition preferably describes a part of a mixing ratio. Ideally the quantity of the ice cream composition in the production process is a multiple of the volume or of the weight inside the package.

In a preferred embodiment the second and third amino acid together are in a ratio between 30:70 and 70:30, preferably between 40:60 and 60:40, preferably 50:50 to the first amino acid. Such a ratio of the proteinogenic amino acids is advantageous, since leucine, isoleucine and valine occur in a similar ratio to one another in the human musculature. Accordingly, the provision of these amino acids to the body by the ice cream composition compensates for the amino acids lost during sport in a characteristic ratio for the body.

It is advantageous if a ratio of the first amino acid to the second or third amino acid is between 85:15 and 75:25, preferably greater than 60:40. It is also conceivable that the second and third amino acid together are preferably in a ratio between 20:80 and 80:20 to the first amino acid. Since leucine has both an anabolic effect, that is to say it builds muscle, and also has an anticatabolic effect, that is to say it counteracts muscle loss, it is advantageous if leucine is present in a higher ratio relative to the other amino acids contained in the ice cream composition.

In a further embodiment a ratio of the second and third amino acid is between 40:60 and 60:40, preferably 50:50. The provision of these amino acids to the body by the ice cream composition compensates for the amino acids lost during sport in a characteristic ratio for the body. Ideally a ratio of the first, second and third amino acid is therefore between 2:1:1 and 8:1:1, preferably between 8:1:1 and 12:1:1.

In one embodiment the ice cream composition contains glutamine, which is formed in particular as an L-enantiomer. Glutamine serves to accelerate the regeneration after training by refilling the body's glycogen stores and thus its energy stores. An ice cream composition with glutamine and proteinogenic amino acids is therefore advantageous, because not only are the energy stores of the body topped up again, but also the muscle renewal is promoted by the amino acids.

It is advantageous if the liquid has a pH value between 6.5 and 8.5. A neutral, non-acidic water composition is economically viable in many places. Therefore the ice cream composition benefits not only from good biocompatibility, but preferably also can be produced favourably and with a low risk of supply bottlenecks.

In a further embodiment the ice cream composition contains at least one thickening agent, at least one sweetening agent and/or at least one coloring. It is conceivable that the thickening agent is one of the substances gum arabic, agar, xanthan gum, lecithins, pectin, guar, guar gum, locust bean gum, carrageenan, gellan, or another substance from the group of linear or branched macromolecules, such as for example polysaccharides. A thickening agent serves to optimise processability of the ice cream composition and increases the pleasure of consuming it.

Ideally the ice cream composition also has a sweetening agent in order to ensure a pleasant taste for the consumer if the natural taste of the amino acids glycine, leucine or isoleucine is not sufficient. Moreover, the ice cream composition even at least one coloring, preferably a plurality of colorings, selected from the group of natural or artificial colorings. Colorings make the outer appearance of the ice cream composition attractive for consumers. In this case this coloring/these colorings is/are preferably plant-based and in particular are selected from at least one of the groups of carotenoids (for example beta carotene), quinone and anthraquinone colorings (for example carmine), flavonoids and/or indigo colorings. Such colorings have the advantage that they are well tolerated by the body. For example, an ice cream composition can contain safflower as red coloring agent. It is also conceivable that the ice cream composition includes natural antioxidants. As a result the by oxygen effects oxidative decomposition of sensitive ingredients of the ice cream caused by oxygen can be prevented. The reduction of the oxidative decomposition of ingredients of the ice cream composition can counteract the change in the taste and/or the smell. The antioxidants used are preferably naturally and endogenously occurring substances. Such substances are preferably secondary plant substances such as carotenoids, flavonoids, anthocyanins, phyto-oestrogens, nordihydroguaiaretic acid or other plant-based antioxidants. It is conceivable that ascorbic acid with at least one further plant-based substance are contained in the ice cream composition as natural antioxidants. In particular, the use of synthetic preservatives in the ice cream composition can be completely avoided by the use of plant-based substances as antioxidants.

In a further embodiment the ice cream composition preferably contains polydextrose. Polydextrose is preferably used as filler in the ice cream composition. The physiological calorific value of the ice cream composition is reduced and/or the volume of the ice cream composition is increased by such fillers. It is also conceivable that yet more fillers are used in the ice cream composition in addition to water and polydextrose. The fillers used in the ice cream composition can preferably also act as fibre for the ice cream composition.

In an advantageous embodiment the sweetening agent includes acesulfame, maltitol and/or sucralose. It is also conceivable that the ice cream composition includes a sugar substitute, for example xylitol, stevia, erythritol, aspartame, sodium cyclamate, saccharine sodium, thaumatin, isomalt, mannitol and/or sorbitol exhibits. Such a sweetening agent and/or sugar substitute can support low-carbohydrate nutrition by the ice cream composition. The sweetening agent preferably does not form any nutrient for microorganisms. This characteristic is crucial for the use than sweetener in the ice cream composition. It is possible that the carbohydrate content and sugar substitute content in an ice cream composition depends upon the natural sweetening agent used. Thus an ice cream composition with a peach flavor can have a carbohydrate content of up to 9 g per 100 ml. In an ice cream composition with an apple flavor can have a carbohydrate content of up to 14 g per 100 ml. Overall the carbohydrate content of the sugar-free ice cream composition can vary between 2 g and 15 g per 100 ml. In this context the term “sugar-free” is defined by the Health Claims Regulation (HCR), according to which a food product can be called “sugar-free” if it contains no more than 0.5 g sugar per 100 g or 100 ml. Due to the natural sweetening agent the ice cream composition contains a proportion of natural sugar which is below a limit of 0.5 g per 100 g of the ice cream composition, preferably 0.2 g per 100 g of the ice cream composition.

It is also advantageous if the ice cream composition contains vitamin B6, vitamin B12 and/or vitamin D. The ice cream composition preferably also contains vitamin B2. Such vitamin have a regulating effect in the utilisation of proteins and mineral substances and thus provide a supporting function for the recovery of energy by the proteinogenic amino acid.

In a further embodiment the ice cream composition contains at least one flavor and/or a flavoring substance. It is also possible that the ice cream composition contains vanillin aldehyde and/or ascorbic acid as flavor. The flavoring substance and/or flavor preferably has/have one of the flavors lemon, cola, raspberries, cherry, peach, orange. However, it is also possible that the ice cream composition contains at least one flavoring substance for the flavors of passionfruit, strawberries, blackberries, blueberries, apple, pear, banana, mango, papaya, guava, pineapple, grape, kiwifruit or melon. At best, this flavoring substance is at least one of the aforementioned fruits. The flavor and/or the flavoring substance preferably do not provide any nutrient medium for microorganisms.

However, the ice cream composition preferably contains a plurality of flavoring substances which are ideally selected from at least one of the groups of natural or artificial flavoring substances. The ice cream composition can be set in a targeted manner to the taste of consumers by the selection one or more flavoring substances. Moreover, the production costs of the ice cream composition can be reduced by the use of artificial or natural flavoring substances.

It is also advantageous if the ice cream composition contains at least one or more emulsifiers. The emulsifier is preferably selected from the group of lecithins (for example soya lecithin) or mono- and diglycerides of fatty acids. An emulsifier ensures the miscibility of the contents of the ice cream composition.

It is also advantageous if the ice cream composition is surrounded by a closed package which includes a material in film form. Ideally the material in film form is selected from a thermoplastic plastics material and in particular from the family of polyesters, for example polyethylene, or polyethylene terephthalate, polypropylene, or polyoxymethylene selected. A polyester alternative, such as for example polyethylene dicarboxyfuranoate, can preferably also be used. In the best case the material in film form is impermeable with respect to moisture, liquid, flavorings and/or gases. Such a material is excellent to work with and can be used in various ways, so that packaging costs are kept low. Furthermore, an ice cream composition which is packaged with a material which is impermeable to fluids and flavorings will keep for longer so that drying out and loss of flavor, but also access for microorganisms is prevented.

The closed package can advantageously be heated, in particular together with the ice cream composition and/or without loss of shape and loss of impermeability. The ice cream composition can preferably be heated to a temperature below 90° C., preferably below 85° C., preferably below 80° C. and/or above 65° C., preferably above 70° C., preferably above 75° C. With such a temperature load the package is protected in particular against loss of shape and/or loss of impermeability. In this way the ice cream composition can be pasteurised. It is also advantageous if the ice cream composition is preservative-free. Without preservatives the formation of microorganisms which can have a harmful effect on the human body is very greatly inhibited.

In a preferred embodiment a quantity of the ice cream composition inside the package has a weight greater than 50 g, preferably 60 g, preferably 70 g and/or less than 200 g, preferably 150 g, preferably 100 g. However, it is also conceivable that the weight of the ice cream composition inside the package is greater than 200 g or less than 50 g. The quantity of the ice cream composition preferably corresponds to a volume of 50 ml to 250 ml. Such a quantity is ideally suitable for consumption and supplies sufficient proteinogenic amino acids for maintaining performance.

It is advantageous if the package has a tubular shape. However, it is also conceivable that the package has a different shape, for example round, spherical, oval or polygonal or is rod-shaped or cube-shaped. However, a tubular shape is preferred, since in terms of production technology the ice cream composition can be easily filled into a tubular package. Furthermore a tubular package is advantageous in so far as the portioning of the ice cream composition can be very flexible, so that it is possible to portion different quantities inside the same tube.

In a further embodiment the package has at least one marking. The marking is preferably designed as a colored marking and/or haptic marking. It is conceivable that the marking extends as a colored strip on the package along two directions, for example the length and the width of the package. Markings serve to indicate the contents of the package, that is to say the ice cream composition, if this is visually very similar in different embodiments. Accordingly the different contents can be identified by a marking, so that confusions cannot occur.

In a further embodiment a package filled with the ice cream composition has an internal volume greater than 3 cm³, preferably 5 cm³, preferably 7 cm³ and/or less than 60 cm³, preferably 45 cm³, preferably 30 cm³. However, it is also possible that the volume is greater than 60 cm³. The volume is preferably between 5 cm³ and 30 cm³, since this is particularly convenient for consumers so that the package is particularly easy for consumers to hold.

In a further embodiment a package filled with the ice cream composition has a length greater than 5 cm, preferably 10 cm, preferably 15 cm and/or less than 30 cm, preferably 25 cm, preferably 20 cm. The length is preferably between 10 cm and 25 cm, since this is particularly convenient for consumers so that the consumers can hold the packaging particularly easily in the hand while consuming the ice cream composition.

Moreover, it is advantageous if the ice cream composition is filled into the package. A method for filling a sugar-free ice cream composition into a package, the ice cream composition serving for making an ice cream and containing at least one liquid, the liquid being water and the ice cream composition being present at a temperature below −10° C., preferably 14° C., preferably 18° C. in a solid, frozen, not-shapeable state, the method preferably comprising the following steps:
providing the dry ingredients of the ice cream composition;
providing a liquid, preferably liquid base, preferably the water;
mixing the dry ingredients and the base to a homogeneous consistency;
providing the package;
sealing the package at a first end;
filling the package with the liquid ice cream composition;
sealing the package at a second end;
heating, preferably pasteurizing, the package with the ice cream composition contained therein.

It is conceivable that the ice cream composition initially consists of a plurality of dry ingredients and a liquid base or water. Alternatively or in addition, the ice cream composition could contain a plurality of liquid ingredients. A mixture of the ice cream composition which is ready for use can preferably be produced in a separate mixing process from the dry and/or liquid ingredients and the liquid base. It is conceivable that the dry ingredients are delivered to the liquid ingredients and/or the base with continuous stirring in a suitable stirring device. It is possible that the dry ingredients are added in portions via conveying means, preferably a conveyor belt or a screw conveyor, to the liquid ingredients and/or the liquid base. In order to achieve a particularly homogeneous consistency of the mixture of the ice cream composition which is ready for use, a constant mixing process at an ambient temperature of 18° C. to 27° C., preferably 25° C., is necessary. For this purpose the dry ingredients with the liquid ingredients and/or the liquid base are repositioned by a relative movement so that a new arrangement of all ingredients is produced. Ideally the intensity and direction of the force introduced changes continuously during the relative movement. The new arrangement of all ingredients preferably corresponds to a homogeneity the mixture which is ready for use. Ideally a mixing time of the entire mixing process corresponds to a time which leads to a complete dissolution of the dry ingredients in the liquid ingredients and/or the liquid base. The mixing time preferably depends substantially on a total quantity of all components. An ice cream composition which is ready for use can preferably be already frozen into an ice cream. However, it is also conceivable initially to heat the package with the ice cream composition contained therein, preferably to pasteurise it, in order to extend the shelf life of the ice cream composition.

A prefabricated package can also advantageously serve as a freezing mould for the ice cream. It is conceivable that the package is provided in tubular form, an end of the tube preferably being sealed in a fluid-tight manner. It is also conceivable that the sealing of an end of the package or of the tube is achieved by conventional welding together. After the sealing at one end of the package the liquid ice cream composition is preferably filled into the package. It is conceivable that filling machines for liquids which are conventional in the food industry are used in this connection. After the filling a second end of the package can preferably be sealed in a fluid-tight manner. In a last step the package with the ice cream composition contained therein can be heated. The heating preferably takes place for up to 30 seconds at a temperature between 68° C. and 90° C. Other time intervals for the heating are also conceivable, which depend substantially upon the ingredients used for the ice cream composition. After the heating the package with the ice cream composition contained therein can be frozen into an ice cream.

Further objects, advantages, features and possible applications of the present invention are apparent from the following description of embodiments with reference to examples and/or the drawings. In this case all the features described and/or illustrated, considered alone or in any sensible combination, form the subject of the invention, also independently of their combination in the claims or their dependencies.

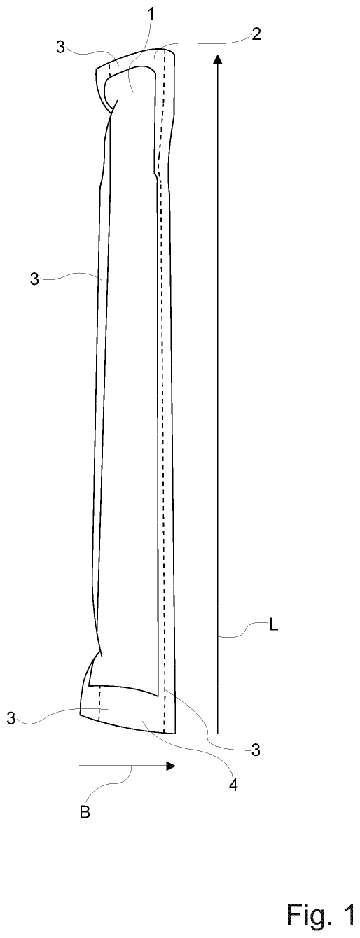

The invention is explained in greater detail below with reference to an example and FIG. 1. However, the example is only exemplary and does not limit the scope of the invention.

The sugar-free ice cream composition (1) preferably contains as principal ingredient soft water with a hardness between 6° dH and 8° dH. The ice cream composition (1) is freezable at a temperature below −10° C. and is then present in a solid, not-shapeable state. Furthermore, the ice cream composition (1) is free of lactose and contains three proteinogenic, preferably branched amino acids.

A preferred ice cream composition (1) contains the following exemplary ingredients:
water
leucine
valine

For adjustment of the taste at least one of the following flavors can be added:
leucine, for a sweet flavor component,
isoleucine, for a sour flavor component,
glycine, for a sweet flavor component,
ascorbic acid, preferably ascorbic acid Pharmacopoeia europaea for an acidic flavor component,
adipic acid for an acidic flavor component, and/or
vanillin aldehyde, preferably vanillin aldehyde Pharmacopoeia europaea for a sweet vanilla flavor component.

The ratios of the ingredients and flavors are variable, in order to adapt the flavor of the ice cream composition (1) in the best possible manner. By way of example three possible compositions may be mentioned at this point.

Composition 1:

Example of a sweet vanilla ice cream composition (1).
75 g water
3.75 g leucine
1.875 g valine
1.875 g isoleucine
0.1 g vanillin aldehyde Pharmacopoeia europaea

Composition 2:

Example of a sweet-sour ice cream composition (1).
75 g water
3.75 g leucine
1.875 g valine
0.2 g glycine
0.1 g adipic acid

Composition 3:

Example of a sour ice cream composition (1).
75 g water
3.75 g leucine
1.875 g valine
0.01 g ascorbic acid Pharmacopoeia europaea

Isoleucine and valine are contained in addition to leucine in the exemplary compositions, isoleucine and valine being present in a ratio of 50:50 to one another. Leucine is contained in a ratio of 2:1 to isoleucine and valine in each case, so that a total ratio of leucine:isoleucine:valine of 2:1:1 is produced. All three proteinogenic amino acids contain the L-enantiomer. Regardless of a quantity of water contained in the ice cream composition (1), the three amino acids are contained together in a quantity of 2.5 g, so that for example leucine is in a quantity of 1.25 g, isoleucine and/or valine are in a quantity of 0.625 g.

Magnesium, vitamin B6, vitamin B2, vitamin B12, vitamin D and/or glutamine in the L-enantiomer can be admixed as an additive to the ice cream composition (1).

Composition 4:

Example of a further ice cream composition (1) with an energy content of 73.35 kJ per 100 ml.
4.3 g per 100 ml carbohydrate
0.2 g per 100 ml sugar substitute
0.23 g per 100 ml protein
625 mg per 100 ml L-leucine
312.5 mg per 100 ml L-isoleucine
312.5 mg per 100 ml L-valine

Further ingredients such as water, fillers, sweetening agents, acidifying agents and coloring agents are contained in the exemplary composition. Polydextrose is preferably contained as filler in an advantageous embodiment of the composition (1). Maltitol and sucralose are advantageously used as sweetening agents. Citric acid preferably also serves as an acidifying agent. It is conceivable that the exemplary composition (1) contains coloring fruit and plant concentrates of carrot, blackcurrants, apple, safflower, lemon, sweet potato, radish and/or cherry. Fats such as saturated fatty acids and salts can preferably be omitted completely from the ice cream composition (1), as set out in the exemplary composition.

FIG. 1 shows a sugar-free ice cream composition (1) which is surrounded by a tubular package (2). 86 grams of the ice cream composition (1) are surrounded by the package, the package (2) preferably having a length (L) of 17 cm and/or a diameter or a width (B) of 2.5 cm. At best the package has an internal volume of 8 cm3. The package (2) has a material in film form made of a thermoplastic plastics material and/or is closed on all sides. In this case the package (2) has weld seams (3) extensively with respect to a longitudinal direction, and on the weld seams a front package element is firmly connected to a rear package element. The ice cream composition (1) is located between the front and rear package elements and/or is surrounded in a spatial direction by the weld seam (3).

The package (3) also has a colored marking strip (4), which extends over the length (L) and the width (B).

The applicant reserves the right to claim all the features disclosed in the application documents as essential to the invention in so far as they are, individually or in combination, novel over the prior art. Furthermore it is pointed out that features which may be advantageous per se have also been described in the example. The person skilled in the art recognises immediately that a specific feature described in the example may also be advantageous without the incorporation of further features from this example. Furthermore the person skilled in the art recognises that advantages may also result from a combination of several features shown in individual examples or in different examples.

### LIST OF REFERENCES

1 ice cream composition
2 package
3 weld seams
4 marking strip
L length
B width

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. Sugar-free ice cream composition for making an ice cream containing at least one liquid, the liquid being water and the ice cream composition being present at a temperature below −10° C., preferably −14° C., preferably −18° C. in a solid, frozen, not-shapeable state, characterized in that the ice cream composition is lactose-free, contains at least one proteinogenic amino acid and is pasteurized, the ice cream composition containing at least one thickening agent, at least one sweetening agent and/or at least one coloring, and the liquid having a pH value between 6.5 and 8.5.

2. Sugar-free ice cream composition according to claim 1, characterized in that the ice cream composition contains at least one second and/or third proteinogenic amino acid.

3. Sugar-free ice cream composition according to claim 2, characterized in that the first amino acid comprises leucine, the second amino acid comprises valine and/or the third amino acid comprises isoleucine.

4. Sugar-free ice cream composition according to claim 1, characterized in that the amino acids are present together in a quantity of more than 1 g, preferably more than 1.5 g, preferably more than 2 g and/or less than 6 g, preferably less than 5 g, preferably less than 4 g.

5. Sugar-free ice cream composition according to claim 3, characterized in that the second and third amino acid together in the quantity of ice cream composition are in a ratio between 30:70 and 70:30, preferably between 40:60 and 60:40, preferably 50:50 to the first amino acid, wherein a ratio of the first amino acid to the second or third amino acid is between 85:15 and 75:25, preferably greater than 60:40, wherein a ratio of the second and third amino acid is between 40:60 and 60:40, preferably 50:50.

6. Sugar-free ice cream composition according to claim 1, characterized in that the ice cream composition contains glutamine, in particular as an L-enantiomer.

7. Sugar-free ice cream composition according to claim 1 characterized in that the ice cream composition contains vitamin B6, vitamin B12 and/or vitamin D.

8. (canceled)

9. Sugar-free ice cream composition according to claim 1, characterized in that the ice cream composition contains at least one flavor and/or an amino acid as flavor.

10. Sugar-free ice cream composition according to claim 1, characterized in that the ice cream composition is surrounded by a closed package which includes a material in film form and/or has a tubular shape.

11. A closed package for a sugar-free ice cream composition, the ice cream composition serving for making an ice cream and containing at least one liquid, the liquid being water and the ice cream composition being present at a temperature below −10° C., preferably 14° C., preferably 18° C. in a solid, frozen, not-shapeable state, characterized in that the ice cream composition is surrounded by the closed package, which includes a material in film form made of a thermoplastic plastics material, the ice cream composition being enclosed between a front and a rear package element and/or is surrounded in a spatial direction by the weld seam.

12. A method for filling a sugar-free ice cream composition into a package, the ice cream composition serving for making an ice cream and containing at least one liquid, the liquid being water and the ice cream composition being present at a temperature below −10° C., preferably 14° C., preferably 18° C. in a solid, frozen, not-shapeable state, comprising the following steps:
providing the dry ingredients of the ice cream composition;
providing a liquid, preferably liquid base, preferably the water;
mixing the dry ingredients and the base to a homogeneous consistency;
providing the package;
sealing the package at a first end;
filling the package with the liquid ice cream composition;
sealing the package at a second end;
heating, preferably pasteurizing, the package with the ice cream composition contained therein.
